(19) United States
(12) Patent Application Publication
(10) Pub. No.: US 2023/0289816 A1
(43) Pub. Date: Sep. 14, 2023

(54) PRIVATE DIGITAL COMMUNICATION SYSTEM AND METHOD FOR REAL-TIME CUSTOMER INTERACTION

(71) Applicant: Phoneternet, LLC, Dallas, TX (US)

(72) Inventors: Adam Ovadia Alfia, Dallas, TX (US); Kfir Alfia, Dallas, TX (US)

(21) Appl. No.: 18/113,880

(22) Filed: Feb. 24, 2023

Related U.S. Application Data
(63) Continuation-in-part of application No. 17/313,872, filed on May 6, 2021.
(60) Provisional application No. 63/314,164, filed on Feb. 25, 2022.

(51) Int. Cl. G06Q 30/015; H04L 51/046; H04L 51/224

(52) U.S. Cl. CPC G06Q 30/015; H04L 51/046; H04L 51/224

(57) ABSTRACT

A private digital communication system allowing customers to interact with a business in real time is disclosed. A web-based platform that allows an easy way for customers to leave real-time feedback via app or website interaction and allows businesses to quickly respond to issues. The system also allows a business to manage the customer feedback by putting notes, tagging issues, close out issues, forward issues via email or text to third parties and generate reports. The system also includes a rating system for users of the platform to rate their experience which gives business owners a quick view of the severity of the customer's experience.

### CROSS-REFERENCE TO RELATED APPLICATIONS

This application is a non-provisional application of, and claims the benefit of, U.S. Provisional Application No. 63/314,164, filed on Feb. 25, 2022, the disclosure of which is incorporated by reference in its entirety. This application also claims the benefit of U.S. patent application Ser. No. 17/313,872 filed May 6, 2021, and claims the benefit of U.S. Provisional Application No. 63/020,892, filed May 6, 2020, the disclosures of which are incorporated herein by reference.

### BACKGROUND

### Technical Field

The present disclosure relates generally to customer experience systems, and more particularly, to a private digital communication system that allows customers to interact with a business in real-time via mobile app or website.

### Description of Related Art

There has been a significant increase in online review sites that allow customers who had bad experiences with a business to leave devastating reviews that can cripple the business. Yet, the business may learn about the issue only after the negative review is posted.

Customers are less likely to write a detailed message via online submission, survey, or paper comment card. Due to social anxiety and fear of making a scene, people are also less likely to let a business' manager know their true experience in a face-to-face conversation. Furthermore, short codes with key words are confusing for average consumers. Many platforms do not allow for the attachment of images or videos, and customers do not have an easy way to designate their response method. Lastly, customers cannot leave anonymous feedback using current platforms since it comes from their cell phone. Oftentimes, anonymous feedback is the most truthful feedback a business can receive. Being that most customers are nervous about a face-to-face confrontation to discuss their issue with management, there needs to be a real-time, simple, electronic method for customers to voice their concerns directly to management while still at the business so that management can address the issue and enhance the customer's experience before the customer leaves the business and possibly writes a negative online review or tells others about the negative experience.

Other current programs use text messaging, emails, surveys, and physical commands to enable customers to communicate with management. However, customers are less likely to use a text platform since short code text platforms and keywords are confusing to customers. Texting a regular phone number gives the impression that you are directly texting the manager which is also perceived as intrusive. Filling out surveys takes too long and rarely addresses the customers' specific issues, face-to-face conversations are intimidating and very few people will write out a physical comment card.

Therefore, what is needed is an easy way for customers to leave real-time feedback and allow businesses to quickly respond to issues.

### BRIEF SUMMARY

The present disclosure is a private digital communication system that allows customers to interact with a business in real-time via mobile app or website interaction through a computing device of a customer with an issue to communicate to a business at which the customer is located. The private digital communication system can include a customer interface for submitting an issue to the business, where the customer interface can comprise a website interface for the business and a Feedback mobile app that is installed on the computing device of the customer, and the customer interface allows the customer to communicate the issue to the business by way of a feedback message submission. The customer can communicate with the interface through a unique business redirection encoding, which can be a customer indication or customer pointer, comprising one of a URL of the website interface for the business and a QR code that is placed at the business location and which can be scanned by a QR code reader device when the computing device of the customer is equipped with a QR code reader device, wherein the unique business redirection encoding loads the website interface for the business on the computing device of the customer or launches the Feedback mobile app on the computing device of the customer. Additionally, a web portal can provide a web service for the feedback message submission from either the website interface or the Feedback app by the customer in relation to the business to be transmitted to an agent of the business in real-time.

### BRIEF DESCRIPTION OF THE DRAWINGS

Having thus described the invention in general terms, reference is now made to the accompanying drawings, which are not necessarily drawn to scale, and which show different views of different example embodiments of the present disclosure, any one of which may be combined in whole or in part with other example embodiments.

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is an illustration of a feedback system comprising a plurality of network connected devices that allow for the communication of user feedback to decision makers of a business in real-time, or near real-time.

FIG. 2 is an illustration of a method for providing feedback to a business from a user.

FIG. 3 is an illustration of a method of determining which communication networks to utilize and how to route the issue.

FIG. 4 is an illustration of a method of activating a trigger for a pre-defined message.

FIG. 5A is an illustration of a feedback system in a configuration mode.

FIG. 5B is an illustration of a feedback system in a code management mode.

FIG. 5C is an illustration of illustration of a feedback system management mode.

FIG. 6A is an illustration of a trigger code display.

FIG. 6B is an illustration of a trigger code activation.

FIG. 6C is an illustration of trigger code activation follow-up.

FIG. 7A is an illustration of a feedback system notification.

FIG. 7B is an illustration of a feedback response system and/or application operated on a computing or mobile computing device in a quick view mode.

FIG. 7C is an illustration of feedback response system and/or application operated on a computing or mobile computing device in a feedback detail mode.

### DETAILED DESCRIPTION

Embodiments of the disclosure will now be described. In the following detailed description of the invention, numerous details, examples, and embodiments of the invention are described. However, it will be clear and apparent to one skilled in the art that the invention is not limited to the embodiments set forth and that the invention can be adapted for any of several applications.

Examples of the disclosure may include a novel private digital communication system and web platform that allows customers to interact with a business in real-time via mobile application (“mobile app”) or website interaction. In some examples, the private digital communication system that allows customers to interact with a business in real-time via mobile app or website interaction involves several components. In yet another example, the components can include a mobile device of a customer with an issue to communicate to a business at which the customer is located and a mobile app that is installed on the mobile device of the customer and allows the customer to communicate the issue to the business by way of a feedback message submission. In some examples, the components include a QR code that is placed at the business location and which can be scanned by the mobile device of the customer with the issue to communicate to the business at which the customer is located. In yet other examples, scanning the QR code by the mobile device of the customer launches the mobile app on the mobile device of the customer. In some examples, the components include a web portal that provides a web service for a customer's feedback message to be created and submitted from either a website or a mobile app by the customer in relation to the business. In yet other examples, the web portal transmits the submitted feedback message in real-time to an agent of the business (such as a manager or employee). In this way, the agent of the business can immediately engage with the customer when the customer is at the location of the business to solve the issue communicated in the feedback message submission or handle the issue and communicate back with the customer via text message, email, phone call, or other mechanisms when the customer is not at the location of the business.

Examples of the private digital communication system that allows customers to interact with a business in real-time via mobile app or website interaction described in this specification differ from and improve upon currently existing options. In particular, some examples differ by using a simple and business-branded web portal, and by promising customers that their comments will be reviewed and considered by management almost instantaneously, customers are more inclined to write detailed feedback about their issues. The only other way that a person could solve a problem or issue they are having with a business is to find and express the problem to a manager at the business in person. However, various studies confirm that people are reluctant to tell the complete and honest truth when conversing face-to-face since they are generally intimidated by confrontation. Furthermore, people do not want to hurt the feelings of someone else when giving them criticism face-to-face. A face-to-face communication of an issue with a manager of a business also does not guarantee that all necessary parties will receive the information about the issue in order to resolve or correct the issue. Furthermore, there is no reliable way to let the customer with the issue/problem know that the issue has been resolved or the problem corrected. There is also no adequate way to document any face-to-face communication of the issue/problem with the resolution/correction (if any), along with notes about how the problem/issue came about or was brought to the attention of the employee or manager, as well as what manner the issue/problem was handled. Also, there is no inherent manner to escalate the issue/problem when the customer expresses it to an employee or manager when the issue/problem cannot be adequately handled, resolved, or corrected by the business employee or manager or others in the business who need to know about the issue/problem and any mitigation, resolution, or correction enacted by the business. Another existing mechanism used by many businesses for customers to submit issue/problem information is by using a business's current feedback loop, such as an online submission or a comment box. The problem with those mechanisms is that by the time that the notice of the issue/problem reaches the appropriate party, any remediation, correction, or resolution of the issue/problem is typically delayed beyond a time duration that could satisfy the customer.

In addition, some examples of the private digital communication system that allows customers to interact with a business in real-time via mobile app or website interaction improve upon the currently existing options by an Artificial Intelligence (AI) layer of software that allows businesses to quickly learn what the issue is about for any given customer and, thereby, prioritize the handling of the issue accordingly.

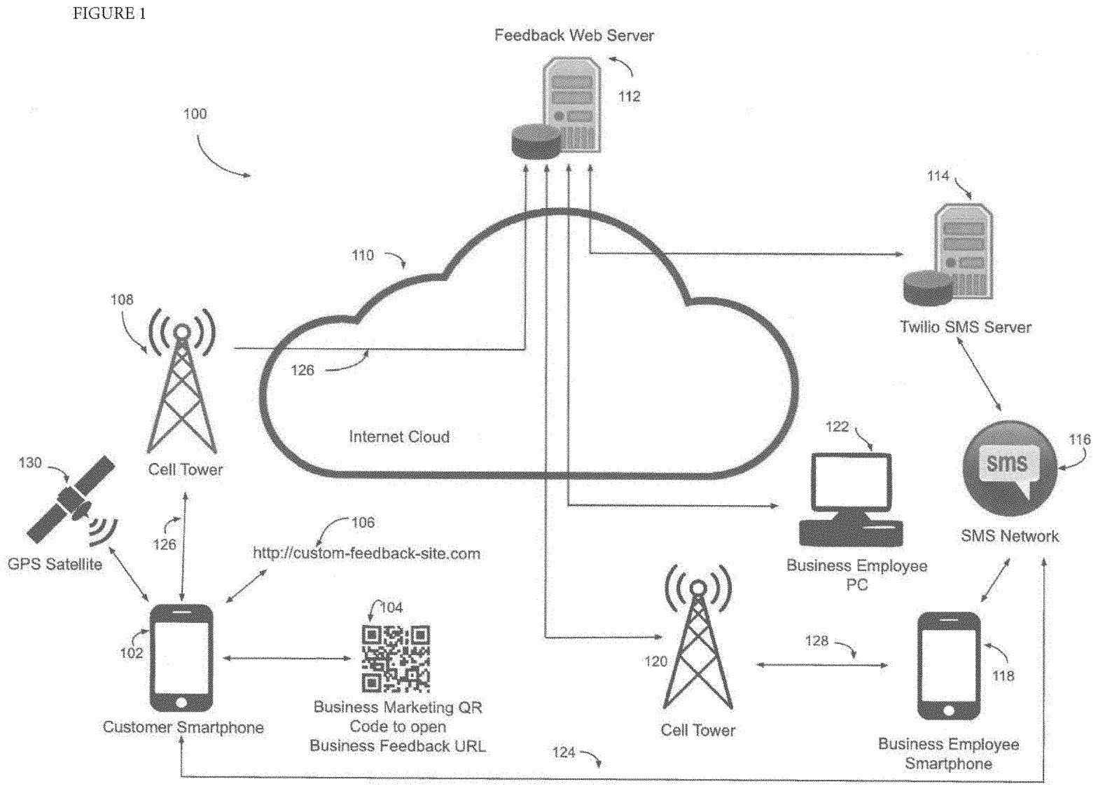

FIG. 1 is an illustration of a feedback system 100 comprising a plurality of network connected devices that allow for the communication of user feedback to decision makers of a business in real-time, or near real-time. For example, a user or customer may have a customer or user device 102 (in at least one embodiment a customer computing device or smartphone). The user can use the user device 102 to access a communication channel 126, through a customer indicator 104 or customer pointer 106. In at least one embodiment, the customer indicator 104 can be a Quick Response (QR) code or bar code that is readable by the user device 102. Alternatively, or in addition, a customer pointer 106 may be a custom or shortened URL, or file path that directs a user to a webpage, or other device accessible media that allows for a user to provide information through inputs to the user device 102. The user device 102 may also include the capture of data from a GPS 130 to include with the information provided by a user. In some examples, data from the GPS 130 can allow for the system to filter out unwarranted or spam information sent to the business implying a need to respond to a non-existent issue.

The user device 102 may communicate through a cell tower or set of cell tower(s) 108. In at least one example, the cell tower(s) 108 may be a cell station, or repeater that allows for communication with a mobile phone or similar user device. Other examples can include 3G, 4G, 5G, LTE, WiMAX, WIFI or other packet-based communication systems. In at least one embodiment, the cell tower(s) 108 allow for communication of information, data, or signals 126 through the internet or internet cloud 110. The information, data, or signals 126 may then be passed, or transmitted to at least one management computing device 112. In at least one embodiment, the at least one management computing device 112 is a server configured to receive, analyze, process, and transmit information, data, or signals 126 to other devices, services, or computing devices. For example, the information, data, or signals 126 can be received by the at least one management computing device 112, the information, data, or signals 126 can include the name of a user, their GPS location, the facility they were at, a subject of the issue, and a description or message, that can then be analyzed, scored, ranked, and transformed into a set of modified information, data, or signals 128 that can be transmitted, or sent to a business device 118. In some examples, the business device 118 may be a computing device, a mobile device, a mobile computing device, and/or a smart or cellular phone. Alternatively, or in addition, the set of modified information, data, or signals 128 may be sent to a third-party service 114, or a business computing device 122.

The third-party service 114 maybe a communication provider, or other communication service that allows for the communication of portions of the set of modified information, data, or signals 128 quickly and efficiently to allow for improved system performance. In at least one example, the third-party service 114 can be Twilio, an SMS service provider that handles, transforms, and modifies information, data, or signals, into SMS messages, or the reverse taking SMS messages and creating information, data, or signals that can be transmitted over various services, or methods. The third-party service 114 may allow for communication to be made over a messaging service 116 that does not utilize packets, or cellular data transmission methods, or alternatively utilizes data packet transmission for the information, data, or signals that may not be in packet form.

The messaging service 116 can allow for communication between a plurality of devices efficiently by allowing multiple information, data, or signal platforms to be utilized with a single transmission. For example, the messaging service 116 may allow the business device 118, and the user device 102 to communication directly while allowing the analysis, transformation, and/or processing by the at least one management computing device 112. In other examples, the messaging service 116 may be utilized to perform actions based on a set of rules provided from the at least one management computing device 112, or through a set of Application Programming Interface(s) (APIs) that allow the at least one management computing device 112 to process and/or analyze messages, information, data, or signals and provide instructions for responses or actions to the messaging service 116. In yet another example, the messaging service 116 may have a pre-defined set of responses or actions to take before the at least one management computing device 112 generates at least one command or notification that is sent to the business devices or business users such as, but not limited to owners, founders, managers, supervisors, or employees.

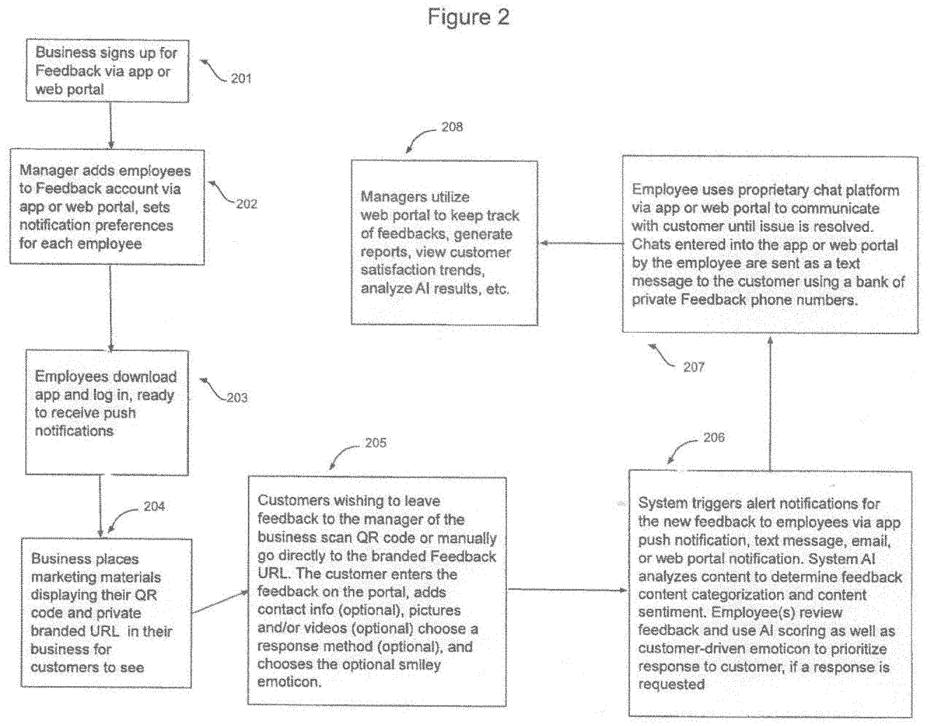

FIG. 2 is an illustration of a method for providing feedback to a business from a user. It would be understood that the method could be implemented through software and hardware interactions in a manner that allows for more efficient communication through increased hardware and software efficiency. Many customers dread pointing out flaws in a business, or love to point out flaws. But what about those customers who just want to leave a comment or note without getting involved? There are limited ways to leave comments, reviews, and/or tips anonymously. As part of the system and method described herein, a user can allow for their contact information to be provided if desired or leave the comment anonymously. Even if the comment is left anonymously, the business can still follow up with the customer regarding any issues, or responses it would like to provide without knowing the customer's identity.

In step 201, a business can sign up for a software application. In some examples, the software application may be executed from a computer readable medium that allow it to be performed by a computing device, or to be performed on a server via a web browser interface. For example, the at least one management computing device 112 of FIG. 1, could be utilized to allow for access of the software application via a web browser or from devices in communication with the computing device in a manner that allows for performance of the software application. Similarly, the software application being executed from a computer readable medium may allow for a smaller or condensed version of the software application to be installed on a user device or a business device such as a smart phone, tablet, or other mobile computing device.

In step 202, a manager or supervisor can add employees of a business to the software application and set at least one preference for each employee. For example, employee 1 may receive phone calls, push notifications or text messages on his/her smartphone while employee 2 receives messages via email. The manager or supervisor may also define the rules for his or her business, such as keywords, phrases, names, or other information or data that are searched for during the analysis and/or processing. In at least one examples, the keywords may include a signature dish of a restaurant, and the sentiment of users giving feedback. Further to this example, a customer may comment on their dish and not provide detailed feedback to the business, but the system can analyze the comment for sentiment providing ranges, specific numbers, and/or scores for each comment regardless of what a user provides as part of the comment.

In step 203, an employee that desires to have messages received on their personal device may download or access a mobile software application, which is capable of communication with at least one computing device running the software application. In at least one example, the communications can be received a push notification on the user's personal device. In at least one example, the mobile software application can provide a link between the user's personal device, or a business computing device, and at least one management computing device. The link may be made through any number of computer networks, and/or communication channels. For example, a user's device may be connected to a WiFi network at the business, which is then connected to an Internet Service Provider (ISP), who provides for the transmission to a second ISP who provides internet to the at least one management computing device or server. A user device may also be coupled to a cellular network, that is then coupled to an ISP.

In step 204, a business can be provided customer indicators, or customer pointers from the software application via at least one computing device in a manner that allows for placement within a business to allow customers to access the customer indicators, or customer pointers. The customer indicators, or customer pointers may include QR codes, Uniform Resource Locators (URLs), shortened URLs, bar codes, number codes, or other methods that allow a person or user to connect with a remote computing device via a cellular or internet-based connection. In at least one example, the connections may be packet-based communication methods. In at least one example, the software application allows for the creation of the customer indicator or customer pointers. The business can utilize the software application and/or at least one computing device to generate customer indicators, or customer pointers, that allow for a customer to provide direct feedback or automated feedback on a specific location. For example, a customer indicator, or customer pointer, may direct the customer to a Tillable field in which a response can be generated and then provided to the business. In other examples, when a customer utilizes the customer indicator, or customer pointer, a specific action is taken such as a message being sent that a particular location (e.g., “Table 1” of a restaurant) needs attention. In at least one embodiment, the customer indicators, or customer pointers, can also be customer branded to the business's logos and/or branding.

In step 205, a customer may be able to access a QR code, or shortened URL that allows them to give feedback to business employees in real-time or near real-time. Once a customer has accessed the customer indicators, or customer pointers they can be directed to form that can be communicated to at least one computing device through a web browser or mobile software application. The customer indicators, or customer pointers, direct a customer's device to software, hardware, or some combination of both that allow the customer to provide feedback to the business through voice messages or notes, text, emojis, video, images, or combinations thereof, that can be transmitted through a computer network or channel such as an ISP, internet connection, cellular connection, or other forms of packet-based communication systems. In some examples, the user may be directed to an email or text messaging service that generates an anonymous account that the user is provided to communicate with the business while maintaining anonymity. In at least one example, the customer can provide text inputs, photos or images, voice recordings, video recordings, and/or other data options, as well as indicate if they would like to receive attention for the issues indicated and if they would like a return communication. Other examples may allow a customer to provide a response number, email, or other communication method and allow the business to know the customer's name and other identifying information.

In step 206, the software application receives the data, information, or signals and utilizes the at least one computing device to analyze the content of the data, information, or signals. The analysis allows the at least one computing device to determine the most effective communication method, which employees to include, and how to address the issues raised through a scoring of the data, information, or signals. All of this is considered with the software application utilize a communications network to provide an employee of the business or user, with the relevant information, issue severity or issue score, and possibly if others are included. The analysis can include multiple calculations. For example, a customer may be asked to provide an emoji indicator of their issue, and these could range from mad, or sad, to neutral, happy, or ecstatic to name a few. From the chosen emoji, a ranking can be provided that allows the system to generate an overall score that can be combined with other indicators. Other examples of the analysis can include natural language, machine learning, and/or artificial intelligence interpretation, extrapolation, and/or processing of the language, emotion, inflections, and/or other verbal, written, and/or visual indicators of a customer's state at the time of providing the information, data, or signals. The customer's state may be indicated as part of an overall score, and/or averaged with the customer provided score to generate the overall score. Additionally, the analysis may be weighted by keywords that will increase or decrease the score dramatically. As an example, the words attorney, lawyer, lawsuit, or judge, may weight the score significantly and/or trigger additional notifications to the manager, owner, and/or supervisor regardless of the overall score. Other keywords may include, but are not limited to, bomb, gun, knife, fight, threats, violence, etc.

In step 207, an employee of a business may access the software application or mobile software application upon receipt of a notification that the software application and/or at least one computing device has received a communication from a customer that included data, information, or signals regarding an issue the customer has had. An employee or user may access a communication or messaging feature that allows for direct communication via the software application or mobile software application with a customer. The notification or communication may include specific scoring, ranking, analysis, and/or processed information that allows for an employee to understand the context, severity, or details of the issue with greater detail. For example, a customer may provide an emoji-based score that differs significantly from the analysis score, which may indicate the customer is unsure of their response or there is a bigger issue than what the customer described. In other examples, additional notifications may be triggered based on individual threshold criteria for each scoring metric. Further to this example, if a customer indicates mad on the emoji score, then the software application and/or hardware may indicate that they want these messages to go directly to a manager or supervisor. These can be created into a pre-defined set of rules that all analysis is performed against. In addition, the keywords may also be utilized as triggers for certain events to occur. In one example, a bomb threat may automatically trigger an alert to local law enforcement and activate local security systems to begin evacuations or lockdown procedures.

In step 208, a manager or supervisor can utilize the software application or mobile software application to view analysis of user or employee interactions, analysis of customer interactions before and after interaction with an employee or user, and/or perform processing of the reports to provide recommended preference changes that will allow the software application to utilize the at least one computing device or communication networks more effectively. In the same way that a customer's information, data, or signals can be analyzed, an employee's or business's responses can also be analyzed to determine if it matches the tones or indicators desired. This can allow businesses to gauge how their customers respond and/or gauge which employees handle customers or situations best. As businesses learn who can provide the best responses and/or resolve issues the best, those employees can be called upon at later times. In at least one example, the system and method can weight these response analysis score as part of the distribution of issues or problems to employees of the company.

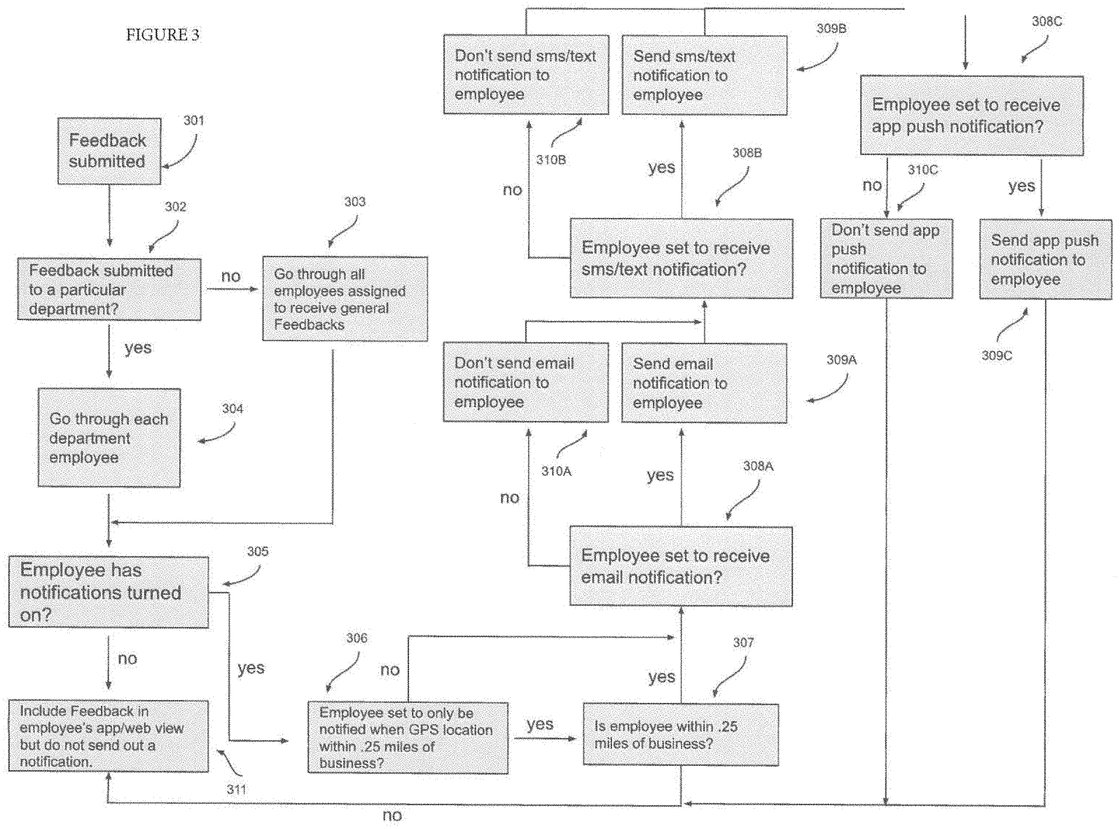

FIG. 3 is an illustration of a method of determining which communication networks to utilize and how to route the issue. For example, an issue may be serious health concerns regarding sanitary conditions which can be routed higher up to a manager or supervisor. The method described in FIG. 3 relates to step 206 of FIG. 2 but can also be implemented within any portion of the software application or system such as the one illustrated in FIG. 1. However, it would be understood that other system implementations could also by utilized.

In step 301, a set of data, information, or signals is received by the software application and/or at least one computing device. The software application may be running and/or executed from a computer readable medium on at least one computing device, such as the at least one management computing device 112 of FIG. 1. In at least one example, the at least one computing device can be a server, or set of servers that allow for execution of the software application, a website executing at least a portion of the software application, and/or access from a mobile software application that performs at least a portion of the software application on a mobile or remote computing device. The set of data, information, or signals may be received over any type of direct, packet-based, or other communication or computer networks that allow for transmission of data or signals across them. In other examples, the set of data, information, or signals may be provided from any device that has access to an internet, cellular, or other computer network or communications channel.

In step 302, the set of data, information, or signals is analyzed, processed, and/or scanned utilizing AI system to determine the context of the data, information, or signals, if a particular department is needed to address issues raised by the context of the data, information, or signals, and/or if a particular employee, manager, or supervisor will need to address the issue. In at least one example, the analysis may provide context for the comment based on outside information. For example, in at least one embodiment, the software application, and/or system can allow for a connection into a business's Point of Sale (POS) system and/or management system to allow for strange or odd interaction to be noted and possibly associated with a particular comment. Further to this example, a customer says they received twice as many of an item than they ordered, and there is a single order that was sent and half of it was returned. These informational insights, while limiting a user's anonymity can allow a user to know if the customer or order puts their entire business in a critical bind.

For example, a customer may provide an emoji-based score that differs significantly from the analysis score, which may indicate the customer is unsure of their response or there is a bigger issue than what the customer described. In other examples, additional notifications may be triggered based on individual threshold criteria for each scoring metric. Further to this example, if a customer indicates mad on the emoji score then the software application and/or hardware may indicate that they want these messages to go directly to a manager or supervisor. In the same way that a customer's information, data, or signals can be analyzed, an employee's or business's response can also be analyzed to determine if it matches the tones or indicators desired. This can allow businesses to gauge how their customers respond and/or gauge which employees handle customers or situations best. As businesses learns who can provide the best responses and/or resolve issues the best, those employees can be called upon at later times. In at least one example, the system and method can weight these response analysis score as part of the distribution of issues, or problems to employees of the company.

In step 303, if no particular department addresses the issues raised then the data, information, or signals can be analyzed, or processed to match with any employee, manager or supervisor that has preferences or experience with the issues raised in the data, information, or signals. In at least one example, the set of information, data, or signal may indicate that a particular action should occur. In these examples, a grocery store may have a customer indicator on each of its carts and/or cart return stations that allow a customer to scan the code to indicate to the business that the parking lot and carts need attention, and this message will be sent any time one of the codes are scanned without a customer having to provide any information, data, or other signals. In yet other examples example, if the information, data, or signals indicate that the issue is related to a particular custom order of a particular dish, the issue would most likely involve multiple groups or departments. However, if an employee has a note that they handle custom orders for the business, then the data, information, or signals can be directed to that employee to address or pass on. In at least one example, an employee can indicate that the issue is not one that they would normally handle, and the information, data, or signals as processed and/or analyzed can be provided to the next employee as determined by the software application and/or at least one computing device.

In step 304, if a particular department addresses the issues raised then the data, information, or signals can be analyzed, or processed to match with any employee, manager or supervisor that works in that department and has preferences or experience with the issues raised in the data, information, or signals. Much in the same way as the example above, a department roster may be analyzed by the software application and/or at least one computing device to allow for more effective distribution of the notifications. In at least one embodiment, the software application and/or at least one computing device may track how many notifications a particular employee is receiving, to limit the overload one individual employee may receive. In yet more examples, the software application and/or at least one computing device can also spread the notifications over an entire department to alleviate one individual from having to address an overload of complaints, and thereby reducing the stress load of each individual in the department. Similarly, the software application and/or at least one computing device can log the number of complaints, issues, or points raised for a particular department, and/or employee. If the software application and/or at least one computing device can determine a particular employee in the department is likely the source of the issues, or discussed within the information, data, or signals received, then the software application and/or at least one computing device can forward those issues to another individual within the same department or team to provide a different insight to the issue. The software application and/or at least one computing device can also anonymize the employees as well as the customer to avoid there being any direct correlation between the two, while providing the proper information to the end user. For example, a customer may raise an issue with a server at a restaurant, and in the replies the server's name may be utilized, but the employee handling the issue will not see the server's name or there will be a pseudonym generated by the software application and/or at least one computing device.

In step 305, the software application and/or system determines the settings of the employee, managers, or supervisor that is matched with the issues raised by the data, information, or signals, if the employee, manager, or supervisor has notifications turned on, notifications are prepared for transmission across multiple different communication network protocols. In today's fast paced world, the quicker an issue can be resolved the better chance that your business will survive without major issues. As with any application or device, the number of notifications can be overwhelming and there should be settings to ensure that notifications are not ignored because of an overload. Additionally, if an employee has multiple channels or means to receive notification then the software application and/or at least one computing device can assist to determine which channel the employee is either actively utilizing at that moment in time or will likely open first. Through logging of activity, as well as user analytics in general it can be determined if an employee receives notifications better through a mobile device push notification, SMS or text message, or an email. This allows the software application and/or at least one computing device to transmit a notification in the most efficient manner to allow for better computing efficiency and communication efficiency via the system.

In step 306, if the employee, manager, or supervisor does receive notifications then the system can analyze the location of the employee, manager, or supervisor's device to determine if they are within a window range of the business location. For example, if the issue needs to be address immediately then an employee, manager, or supervisor that is not on site would likely not receive the notification as another individual on that team would be utilized first. In another example, an employee, manager, or supervisor may have their preferences set to only receive notification if they are within a threshold distance of the business location. In this example, an employee may be 25 miles away from a facility, while a second employee is on site. The software application and/or at least one computing device can utilize employee GPS and/or contact information to determine the best employee to send the notification to. Again, this creates efficiency for the system as well as a user. If a particular employee is unavailable or will not be able to address the issues, then it is highly inefficient to send communications and/or notifications to that employee as it creates unnecessary traffic over communication networks or channels and requires additional computing resources that could be utilized analyzing and/or processing additional information, data, or signals.

In step 307, if the employee, manager, supervisor is within the threshold distance from the business, then a notification is sent based on a set of preferences pre-set by the employee, manager, or supervisor. For example, the employee, manager, or supervisor may have email notifications set in step 308A, similarly they may have their preferences set to receive SMS or text messages in step 308B, and/or have preferences set to receive push notification from the mobile software application in step 308C. While steps 308A, 308B, and 308C are illustrated in a sequential operation, it would be understood that these determinations could also be performed in parallel.

Similarly, if any of the preferences in steps 308A, 308B, and/or 308C are set to yes, then in steps 309A, 309B, and/or 309C, the notification can be sent through the communications network or channel, where step 309A relates to email, 309B relates to SMS or text messages, and 309C relates to push notifications. Alternatively, if an employee, manager, or supervisor does not have their preferences set to receive notifications there one of the communication networks or channels then a notification is not sent through those communication networks or channels such as, but not limited to emails 310A, SMS or text messages 310B, and/or push notification 310C.

In step 311, if an employee, manager, or supervisor does not accept any notifications then the notification can be provided the next time they log into the software application or mobile software application via a computing device, mobile computing device, or web browser.

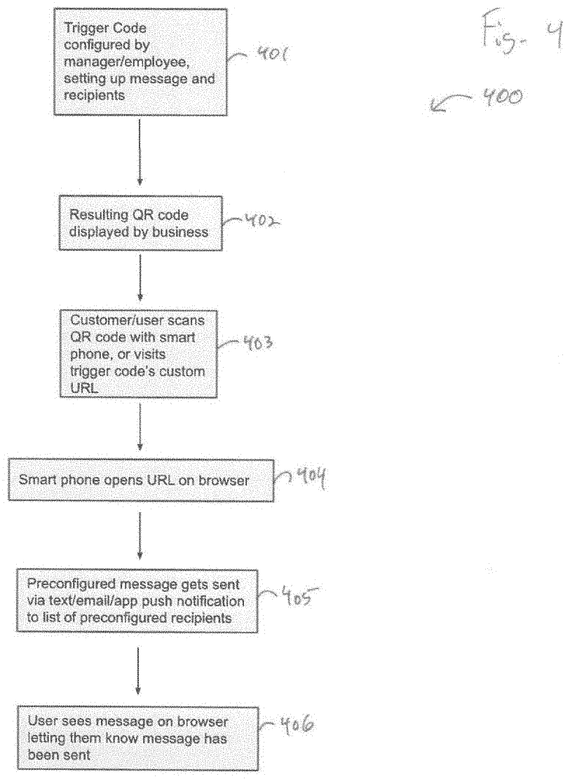

FIG. 4 is an illustration of a trigger code activation method 400. The trigger code activation method 400 can allow for the creation of pre-defined messages that are sent upon activation of a trigger code. In at least one example, the trigger code can be a scannable mechanism such as but not limited to a QR code, bar code, or other digitally created media that a customer or user can scan with a computing device or mobile computing device, which activates an action without any additional user intervention or activity with the computing device or mobile computing device.

For example, a trigger code can be created with a pre-defined message and a sending location for the pre-defined message. The trigger code is placed at a specific location, most often a particular location within a building, with certain parties provided as the receivers for the pre-defined message of that particular location within the specific location. A user can then scan the trigger code, activating the pre-defined message and allowing for it to be transmitted to the parties receiving the message. A user does not have to provide any additional interactions beyond scanning the trigger code. When the pre-defined message is received by a receiving party, additional actions can be initiated, such as but not limited, notices or messages to scheduling and/or inventory regarding the particular location within the specific message. In at least one example, the trigger code may initiate a phone call to a particular user with a pre-defined message.

In step 401, a trigger code can be created and/or configured by a system user, such as but not limited to managers, employees, or executives. The creation and/or configuration can allow for messages and recipients to be configured or created for each trigger code. For example, a trigger code may be a QR code, a bar code, or other scannable mark that can be utilized to cause a computing device to take specific action when captured with an imaging system or other methods of recognition. For example, a system integration can allow for a user to put a trigger code on a trash dumpster and program a location code in the message. When a user scans the trigger code, it would initiate a work order to be processed by the business to come and empty the dumpster without further user input or consumer interaction. The trigger code when scanned and/or captured by a computing device or mobile computing device can activate specific actions by the computing device or mobile computing device that allow it to communicate with a feedback system. These actions may include alerting select individuals at a specific location, sending alerts to scheduling or inventory systems, and/or creating audit logs for specific events and/or activities.

In step 402, a trigger code can be placed in a particular location that allows for users and/or customers of a business or other entity to view the trigger code at a displayed location. For example, a business such as a general store, may use trigger codes in each bathroom to indicate when particular items are not working or when items are empty. The trigger code may include location information, specific item information, and/or any other information that it is configured to contain.

In step 403, a user and/or customer of a business or other entity can scan and/or capture the trigger code with a computing device or mobile computing device, causing an action to occur. In some examples, the trigger code can cause the computing device or mobile computing device to open a specified URL that initiates background website code operations. In other examples, the trigger code may cause the computing device or mobile computing device to initiate operations on the device without necessitating the opening of a URL or browser. Further to these examples, a non-URL initiated operation may include sending an SMS or other packet-based message, such as an email or other types of communications that can be initiated through computing or mobile computing devices.

In step 404, the computing device or mobile computing device can open and/or activate the operational code of the trigger code. It would be understood, without departing from the spirit of this disclosure, that other types of code, operations, or actions could be conducted by the computing device or mobile computing device. For example, the computing device or mobile computing device can include the ability to process specific commands that may be stored as part of a computer readable medium. Additionally, the trigger code may allow for different types of computing or mobile computing devices to utilize various methods for accessing instructions that allow the computing or mobile computing device to perform processing, operations, actions, or other tasks performable by a processor enabled device such as a computing or mobile computing device.

In step 405, a pre-defined or pre-configured message can be sent to a receiving device or system through any packet-based communication system to recipients specified as part of the pre-defined or pre-configured message. For example, a system user, such as but not limited to managers, employees, or executives, can set the intended recipients for particular pre-defined messages. In at least one example, a set of rules may be utilized to determine if escalation is needed to achieve a desired outcome. Some examples of rules may include sending a message or notice to an inventory system when more than one pre-defined message is received from the same location and/or item. Other examples may include, sending a pre-defined message to different people if the same code is scanned or captured within a specific time period. Similarly, these operations may be performed in serial (sequentially) or in parallel.

In step 406, a user that has scanned or captured the trigger code with a computing or mobile computing device can receive a confirmation that a pre-defined message was sent. In at least one example, the confirmation can be displayed via a URL or other in browser message. In yet other examples, a push notification, SMS, email, or other forms of packet-based communication may also be utilized.

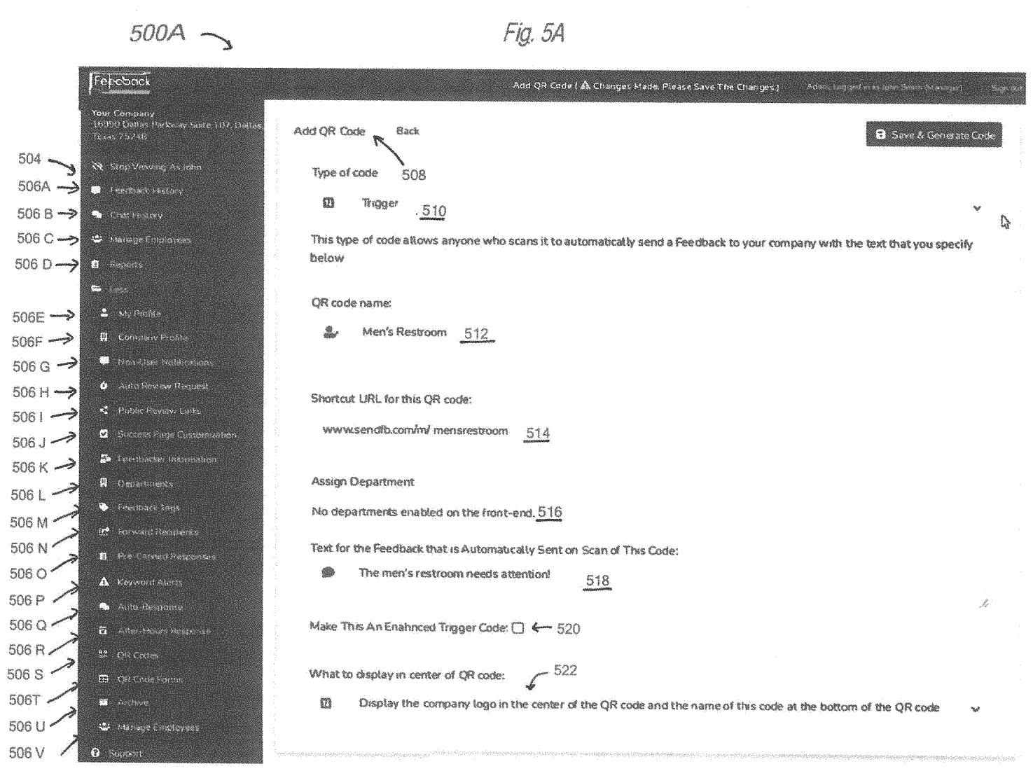

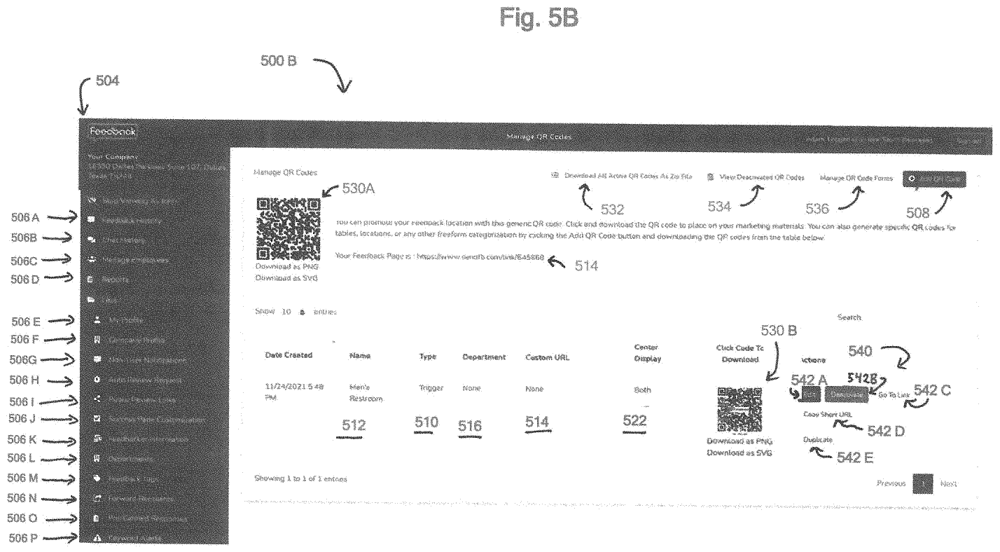

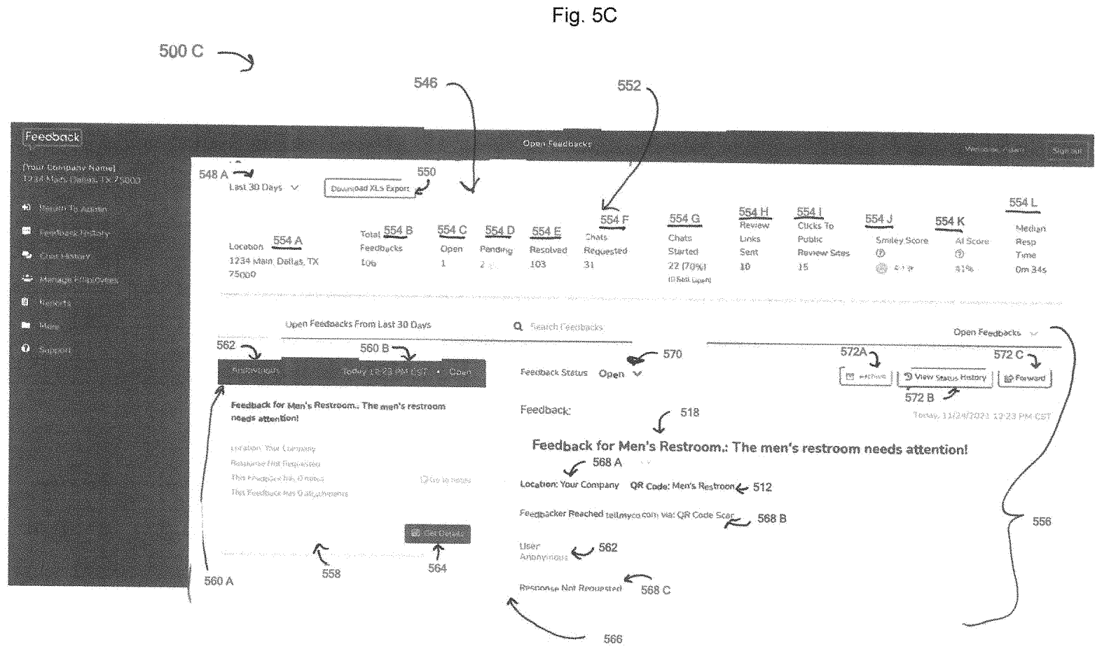

FIG. 5A is an illustration of a feedback system in a configuration mode 500A. The configuration mode 500A allows for a pre-defined message to be created and/or configured in a manner that follows user defined rule sets or operations. For example, a pre-defined message can be created that allows for communication of information in a non-intrusive manner for users. A user can scan or capture the code and have the message sent without any additional interactions. These additional interactions may include a user entering information and/or providing additional engagement beyond a single click if needed.

A user can access a menu 504 that allows for navigation through the feedback system. For example, a user may select a feedback history button 506A, a chat history button 506B, a manage employees button 506C, a reports button 506D, a my profile button 506E, a company profile button 506F, a non-user notifications button 506G, an auto review request button 506H, a public review button 506I, a success page customization button 506J, a feedbacker information button 506K, a departments button 506L, a feedback tags button 506M, a forward recipients button 506N, a pre-canned responses button 506O, a keyword alerts button 506P, an auto-response button 506Q, an after-hours response button 506R, a QR codes button 506S, a QR code forms button 506T, an archive button 506U, and a manage employees button 506V, all of which are examples of the various types and/or functions these buttons may be utilized for, and additional examples along these lines would not depart the spirit of the present disclosure. Each of these buttons (collectively, menu buttons 506) can allow for a user of the feedback system to navigate and access additional screens, operations, and/or configurations of events or actions.

By way of example and not limitation, the feedback history button 506A can allow a user to review previous feedback messages or actions from users, such as but not limited to the pre-defined messages. Other examples may include the profile buttons, which allow a user to define parameters of their personal and company preferences. An example of a chat history button 506B gives a user access to previous chat transcripts and interactions from users. One example of a manage employees button 506C might display an interactive list of current and past employees utilizing the feedback system. A user could potentially use this example to access the feedback history or chat history of each employee. An example of a reports button 506D allows a user to review, generate, and customize various reports generated from the data received by feedback system. Examples of reports available at the example of the report button 506D could include response time reports, employee productivity reports, areas of high report frequency, and more. In one example, the my profile button 506E might allow the user to view a user profile displaying information about the user. In this example, the user profile might be customizable and have various settings dependent on whether a fellow employee or a feedbacker is viewing the user profile. An example of a company profile button 506F could allow the user to view information about the company utilizing the feedback system. A non-user notifications button 506G example might allow a business to send notifications via email or text about new Feedbacks submitted by customers to people who are not Feedback backend users. For example, a business might want a third-party marketing or PR team to receive Feedback notifications as they come in to preemptively handle issues that may damage a business' reputation. The auto review request button 506H could allow businesses to automatically send a customer a text message 24 hours after their Feedback was marked as “Resolved” by the business, asking the customer if the customer's issue has been resolved. If the customer responds to the text message with “No,” then the business can be immediately alerted about the issue via email. If the customer responds with “Yes,” then the system may send a request to leave the customer a review. The customer is sent to a site, which may be called RateThisBiz.com to leave the review. If the customer leaves the business a 1-3 star review on RateThis Biz.com or another linked review website, they can be asked to either continue exploring a solution with the business or to write a review about the business. The business can then be immediately notified that a customer left them a negative review. If the customer selects a 4 or 5 star review, they are sent to Google or other public review site to leave a public review. All reviews left on Google can be automatically monitored by the system or related companies and populated into a link called “Google Review” or “Public Review” (links not shown), that not only shows the business all of the business' recent public reviews, but also allows them to track how many customers left public reviews directly attributed to come from the system. Button 506I (may also be called a public review button) allows a business to designate which public review sites they want their customers to be directed to once the customer's issue is resolved. Button 506J (can also be called a success page customization button) allows a business to designate the information displayed on the success page after leaving a Feedback. For example, allowing a business or user to customize the “success” page or interface shown to a feedbacker after submitting a Feedback. Button 506K (may be called a feedbacker information button) allows a business to download a list of all the people that have ever left them a Feedback along with the number of Feedbacks they have submitted in the past, as well as any contact information that they have shared when leaving Feedbacks. Button 506L allows a business to create certain departments that users could designate as the location for their issue. Business can also assign specific individuals to a department so that only those individuals would be alerted for a Feedback sent to that department by a customer. Button 506M (sometimes called a feedback tags button) allows a business to create custom tags so that when Feedback is left, a business can tag the Feedback with specific types of areas of concern so that the business can build reports based on those Feedbacks. For example, various reports, dashboards, or other activities (both manually activated or activated via computer based automation) can utilize tags to generate said reports or dashboards, or to present the results of the other activities. Button 506N (may be referenced as a forward recipient's button) allows a business to preselect certain individuals that a manager can quickly forward a Feedback to. Alternatively, there may be rules associated with the forwarding and/or individuals that allow for the forwarding to occur based on system, business, or user specified conditions such as, but not limited, time of day, keywords in message, location of trigger code, physical location of user, number of feedbacks from trigger code, and/or other similar based requests. Button 506O (can be referenced as pre-canned responses button) allows businesses to create pre-canned responses to Feedback so that employees can quickly choose from a list of pre-canned responses for common issues so that they do not have to type out the response over and over. In at least one example, the pre-canned responses may also include a set of rules that allow for responses to be sent to the customer based on particular context of their feedback message. Button 506P (sometimes referenced as a keyword alerts button) allows a business to select keywords that are either used in the initial Feedback sent by a customer or in the subsequent communication with the business. Each message can be analyzed for those particular key word(s) and an alert is sent either by email or text message to pre-designated individuals that one of the key words was used for heightened attention to that particular Feedback. For example, various reports, dashboards, or other activities (both manually activated or activated via computer based automation) that utilize keywords to generates said reports, dashboards, or present the results of the other activities. Alternatively, there may be rules associated with the keywords that allow for the forwarding of messages to occur based on system, business, or user specified conditions. Button 506Q (may also be referenced as an auto-response button) allows businesses to determine an auto response that is sent to someone who submitted a Feedback letting them know that their Feedback has been received. The message can be sent out after a pre-determined amount of time has elapsed. Button 506R (can be referenced as an after-hours response button) allows a business to designate the hours of operation of that business and customize a message that would be sent to someone who submitted a Feedback outside of those hours of operation. For example, there may be rules associated with the after-hours response that allow for the forwarding of messages to occur based on system, business, or user specified conditions. Button 506S (may also be referenced as a QR codes button) allows a business to create a multitude of QR code types, including the Trigger and Enhanced Trigger codes. Alternatively, a list of the various QR codes currently and previously in use by the feedback system may be shown to a user. Button 506T (sometimes referred to as a QR code forms button) allows business to create customized forms that can be accessed by a QR code or by a customer visiting a specific URL. For example, these forms may ask for specific categories of information and/or rankings to allow for better information. Button 506U (may be referenced as an archive button) allows a business to archive a Feedback that a business might not want the rest of the employees that have access to the Feedback system to have access to. Button 506V (may be referenced as a manage employees button 506V) allows businesses to add and manage employees as well as assign specific rights and departments to that employee. Furthermore, a manager can determine the types of notifications that the employee would receive and where the employee needs to be in order to receive those messages and alerts.

A user can use an add QR code (or other scannable item) button 508 to enter the configuration mode 500A for a new QR code or other scannable item. The configuration mode 500A can allow for the type of code 510 to be selected, a name given to the code 512, a URL 514 given for the specific code, a department assigned 516 to the code, a pre-defined message provided 518, the code enhanced 520, and provide a center display 522. The type of code 510 can be a trigger code or other code types that allow for minimal user engage with their computing device or mobile computing device. For example, another code type might allow for the downloading of an app or other material without the user having to engage with their device, or alternatively, may cause the mobile or computing device to create new data on the device that is saved in the device's local storage or memory. The name given to the code 512 can allow for the identification of the specific code when listed with other feedback codes. The URL 514 can allow for a user to be directed to specific locations on the Internet, which may cause additional actions, operations, information, or other data to be displayed, provided, and/or processed.

The department assignment 516 can allow for locations with defined sections and/or areas to indicate which group of employees may have access to the information provided. For example, if a trigger code is utilized in an area of a specific location that has a restroom, a user can scan or capture the trigger code and alert or notify employees working that department that the restroom may need attention. In some examples, rules may be put in place to prevent notifications being sent to department employees unless certain conditions are met. Additionally, in some examples, heads of a department may be notified if a specified number of notifications from a particular trigger code have been received. The pre-defined message 518 can be intended for users, customers, executives, employees, or any other desired recipient. For example, if the pre-defined message 518 is directed to employees of an entity utilizing the feedback system, then the message may include information about the location and items needing attention, stocking, cleaning, and/or other engagement or interaction from employees. The differentiating characteristic of the trigger code is that it will send a predefined message through the Feedback system just by scanning the trigger code. The user does not have to do anything but scan the code.

An enhanced trigger code 520 can allow a user to send a pre-defined message, but also include additional information such as, but not limited to contact information, images, additional text or messages, and/or a score or other emotional indicator. For example, an enhanced trigger code 520 can pre-populate the Feedback window on a users device with a pre-determined message that can be edited by the user to include additional important information. Additionally, it may allow for a user's contact information to be gathered so rewards or thank you information can be provided. In at least one example, the trigger codes, enhanced or unenhanced, may allow for connectivity through application programing interfaces (APIs) to other systems via the feedback system. For example, if an enhanced trigger code is utilized and a user provides their contact information, that contact information may be forwarded to a company's customer relationship management (CRM) system. Further to this example, employee management, employee scheduling systems, alert system, inventory systems, and/or other business operation system may be accessed via the APIs.

FIG. 5B is an illustration of a feedback system in a code management mode 500B. The code management mode 500B allows for the trigger code 530A to be displayed as it would be to a user at a store or other location. Additionally, a download all active codes button 532, a view deactivated codes button 534, a manage code forms button 536, and a add code button 508 may be provided to a system user. A promotion URL or code 514 may also be displayed to allow users to promote their tools and/or vendors, and in at least one example, a referral fee may be paid back to the user or their company if the promotion URL or code 514 is accessed. The code management mode 500B can also allow for the ability to manage the QR code 540 through an edit button 542A, a deactivate button 542B, a go to link button 542C, a copy URL button 542D, and a duplicate button 542E.

A User can access a menu 504 that allows for navigation through the feedback system. For example, a user may select a feedback history button 506A, a chat history button 506B, a manage employees button 506C, a reports button 506D, a my profile button 506E, a company profile button 506F, a non-user notifications button 506G, an auto review request button 506H, a public review button 506I, a success page customization button 506J, a feedbacker information button 506K, a departments button 506L, a feedback tags button 506M, a forward recipients button 506N, a pre-canned responses button 506O, a keyword alerts button 506P, an auto-response button 506Q, an after-hours response button 506R, a QR codes button 506S, a QR code forms button 506T, an archive button 506U, and a manage employees button 506V, all of which are examples, and additional examples along these lines would not depart the spirit of the present disclosure. Each of these buttons (collectively, menu buttons 506) can allow for a user of the feedback system to navigate and access additional screens, operations, and/or configurations of events or actions.

An example of a chat history button 506B gives a user access to previous chat transcripts and interactions from users. One example of a manage employees button 506C might display an interactive list of current and past employees utilizing the feedback system. A user could potentially use this example to access the feedback history or chat history of each employee. An example of a reports button 506D allows a user to review, generate, and customize various reports generated from the data received by feedback system. Examples of reports available at the example of the report button 506D could include response time reports, employee productivity reports, areas of high report frequency, and more. In one example, the my profile button 506E might allow the user to view a user profile displaying information about the user. In this example, the user profile might be customizable and have various settings dependent on whether a fellow employee or a feedbacker is viewing the user profile. An example of a company profile button 506F could allow the user to view information about the company utilizing the feedback system. A non-user notifications button 506G example might show a user notifications from a non-user of the feedback system. For example, an employee may not have access to a computing device or mobile computing device, but can be reached through other communication methods such as text or instant messaging, which can be shown in non-user notifications area. One example of an auto review request button 506H might allow for messages to be analyzed for particular key words or message content and can process those messages accordingly. An example of a public review button 506I might show inquiries in which the public at large provided feedback for the user to review for accuracy. Alternatively, the public review can allow for certain messages to be placed on public forums, website, and/or social media. An example of the success page customization button 506J could provide a user an interface in which they can customize the “success” page shown to a feedbacker when submitting an inquiry. In an example, the feedbacker information button 506K might allow a user to review demographic data about the feedbacker collected from the feedbacker while using the feedback system. An example of the departments button 506L could allow a user to view feedback categorized into various groups. An example of a feedbag tags button 506M might allow a user to view further categorized feedback according to a user's or company's preferences. In an example, a forward recipients button 506N can allow for message rules to be established for the forwarding of feedback responses to particular individuals of a business or entity. A pre-canned responses button 506O example might include messages that can be utilized for various responses to feedback provided from customers and/or users. In at least one examples, the pre-canned responses may also include a set of rules that allow for responses to be sent to the customer based on particular context of their feedback message. An example of a keyword alerts button 506P might display to a user a list of pre-configured keywords that act as a trigger to alert a user of feedback received based on certain parameters.

FIG. 5C is an illustration of illustration of a feedback system management mode 500C. A User can access a menu 504 that allows for navigation through the feedback system. For example, a user may select a feedback history button 506A, a chat history button 506B a manage employees button 506C, a reports button 506D, a my profile button 506E, a company profile button 506F, a non-user notifications button 506G, an auto review request button 506H, a public review button 506I, a success page customization button 506J, a feedbacker information button 506K, a departments button 506L, a feedback tags button 506M, a forward recipients button 506N, a pre-canned responses button 506O, a keyword alerts button 506P, an auto-response button 506Q, an after-hours response button 506R, a QR codes button 506S, a QR code forms button 506T, an archive button 506U, and a manage employees button 506V, all of which are examples, and additional examples along these lines would not depart the spirit of the present disclosure. Each of these buttons (collectively menu buttons 506) can allow for a user of the feedback system to navigate and access additional screens, operations, and/or configurations of events or actions.

An example of a chat history button 506B gives a user access to previous chat transcripts and interactions from users. One example of a manage employees button 506C might display an interactive list of current and past employees utilizing the feedback system. A user could potentially use this example to access the feedback history or chat history of each employee. An example of a reports button 506D allows a user to review, generate, and customize various reports generated from the data received by feedback system. Examples of reports available at the example of the report button 506D could include response time reports, employee productivity reports, areas of high report frequency, and more.

The feedback system management mode 500C allows for information regarding feedback responses to be analytically presented as a report 546. For example, a time frame 548 can be defined for the analysis. A report export button 550 can allow for a formatted report to be generated and made available for a system user. The details of the report 552 may include a location 554A, the number of feedbacks 554B, the number of open matters 554C, the number of pending matters 554D, the number of resolved matters 554E, the number of chat requests 554F, the number of chats started 554G, the number of review links 554H, the number of clicks of review links 554I, the smiley score 554J, the AI score 554K, and/or a response time metric 554L. The AI score may be determined by using Google's AI (Artificial Intelligence) API or other similar services to assign a score of 0-100 to the initial Feedback that a user sends. Google's AI looks for key words in the Feedback and gives us back a rating. In these and similar examples, the key words may be Feedback system defined, user defined, or Google AI defined. The feedback system can then convert that rating on a 0-100 scale to help the business determine the user's sentiment at the time that the Feedback was submitted.

A feedback review section 556 can allow for any of the report 546 analysis to be reviewed in more detail. For example, a quick view section 558 can allow for details of a particular feedback request to be viewed by a system user. In this example, the party 560A providing the feedback response and the date 560B of the feedback response can be provided in the header 562 of the quick view section 558. A details button 564 can open the details section 566 for each of the viewed feedbacks in the quick view section 558. The details section 566 can allow for each of the feedback responses to be reviewed in detail, letting a user know the location of the business 568A, which trigger code 512 was utilized, how the trigger code was accessed 568B, the feedback provider 562, and/or the feedback message 518. In some examples, the user may also request a response 568C and that may also be visible to a feedback system user. The status 570 of the feedback response can be indicated as well. If a feedback system user would like to update the status 570, archive 572A, view the status history 572B, or forward 572C the feedback response, this can be done through user engagement. In at least one example, the user engagement can be conducted through interactive buttons.

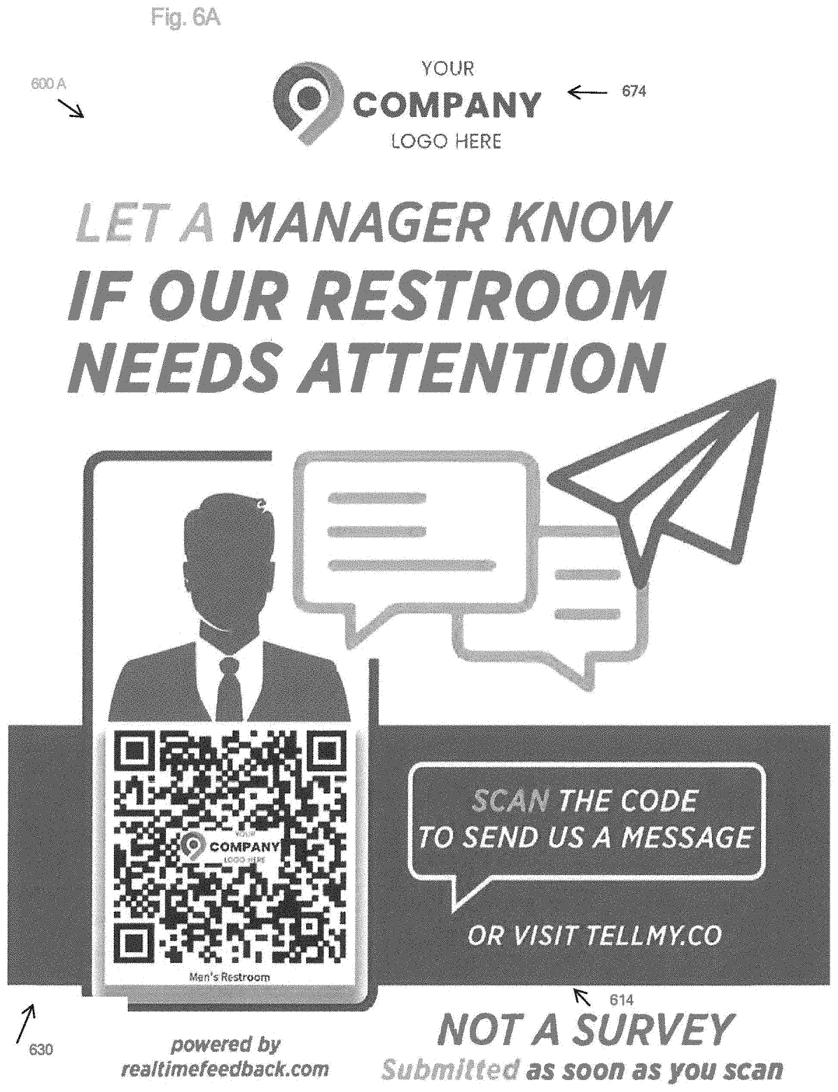

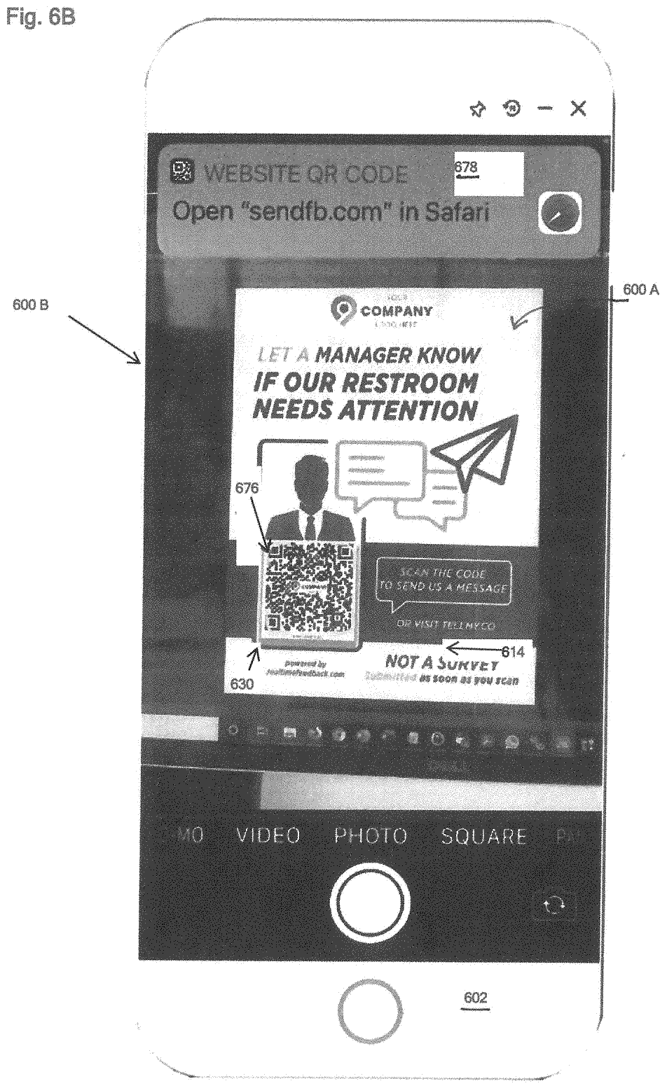

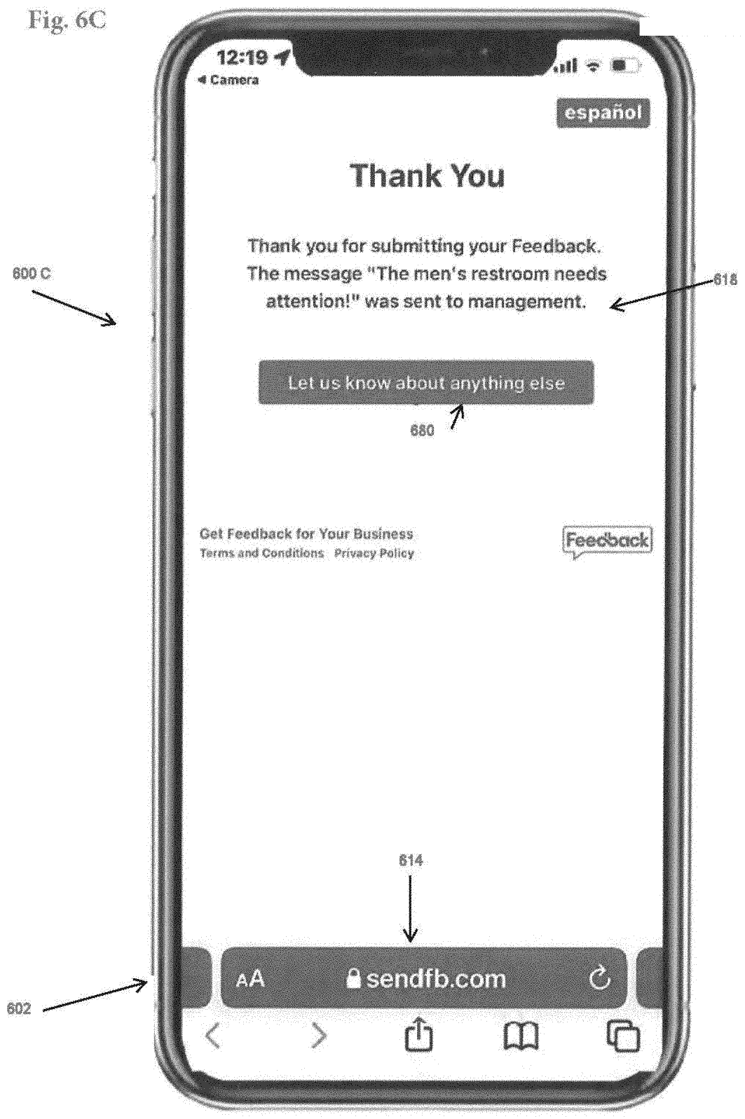

FIG. 6A is an illustration of a marketing piece that displays the trigger code. The trigger code display 600A allows a company to provide a visual indicator that a user can provide feedback. For example, the company can have their logo 674 on it, provide a specific URL 614 for sending additional feedback, and/or other pertinent information or advertising. The trigger code 630 can be scanned or captured by a computing or mobile computing device operated by a user, which can activate or open the URL 614 that can trigger or cause a pre-defined message to be sent to the feedback system without the user having to do anything else other than scanning the code.

FIG. 6B is an illustration of what the user's phone or alternate device looks like when scanning a trigger code 600B. Currently, devices may alert a user that the user is being asked to go to an online portal. Once the user authorizes the phone to go the portal, the Feedback system triggers the pre-determined message to be sent through the Feedback system to the pre-designated recipients. The trigger code displayed allows a company to provide a visual indicator that a user can provide feedback. For example, the company can have their logo 674 on it, provide a specific URL 614 for sending additional feedback, and/or other pertinent information or advertising. The trigger code 630 can be scanned or captured by a computing or mobile computing device operated by a user, which can activate or open the URL 614 that can trigger or cause a pre-defined message to be sent to the feedback system.

A computing or mobile computing device 602 can be utilized to capture or scan the trigger code 630. A capture or scanning area 676 may highlight the trigger code 630 and indicate where the computing or mobile computing device 602 is scanning or capturing. In at least one example, when the computing or mobile computing device 602 scans or captures the trigger code 630, a notification or window 678 will be provided for a user to select. This prevents random codes from being activated with open cameras. However, some devices do allow for these types of system and allow for code activations without user interactions or engagements with the computing or mobile computing device 630.

FIG. 6C is an illustration of trigger code activation follow-up 600C. When a computing or mobile computing device 602 scans or captures the trigger code (seen as 630 in FIGS. 6A and 6B) the activation can open a URL 614 during the activation. The trigger code activation follow-up 600C may include a response message 618 that allows an entity to inform the user that the feedback was sent. When using the enhanced trigger code, there may also be an add information button 680 that allows a user to further engage with a feedback system. The success page language can be customized by a business using the Feedback management portal.

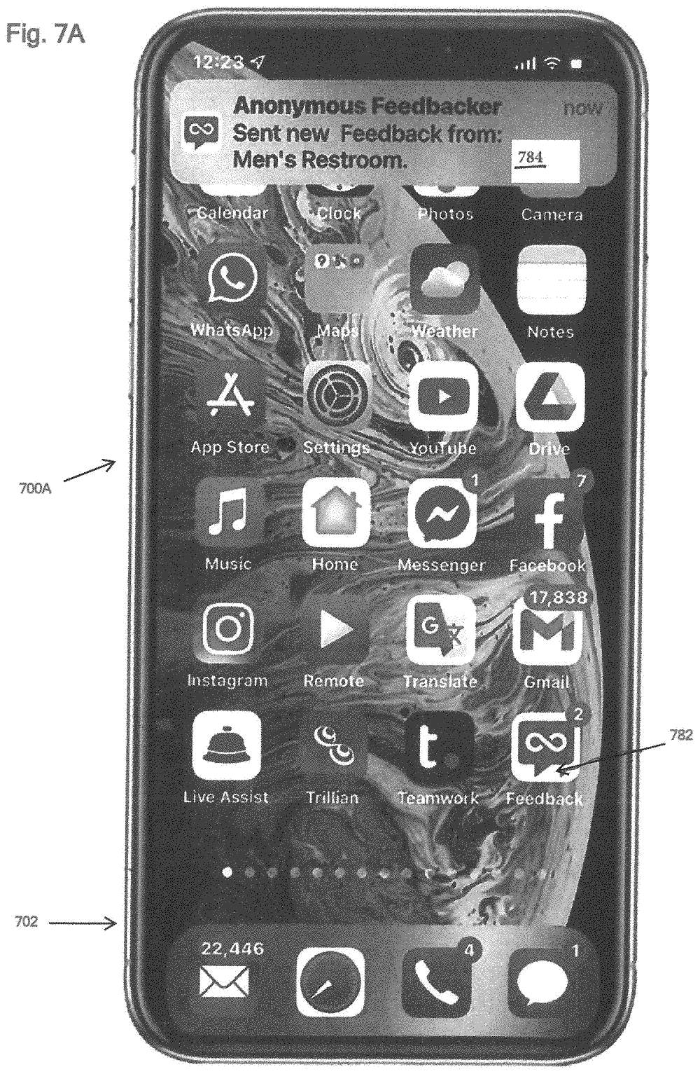

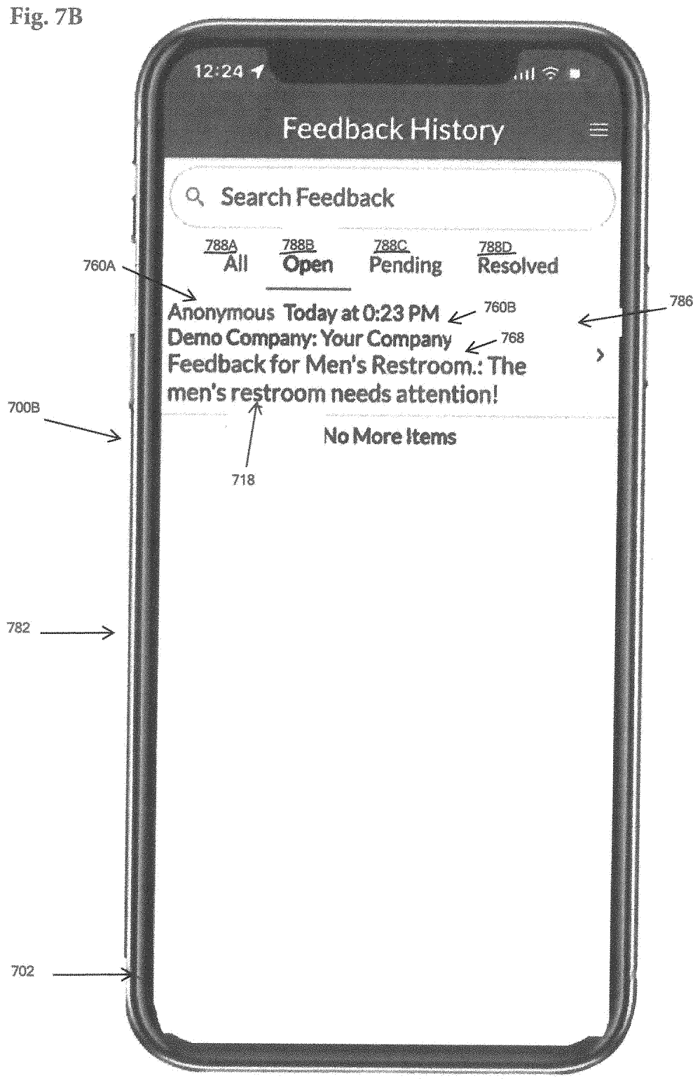

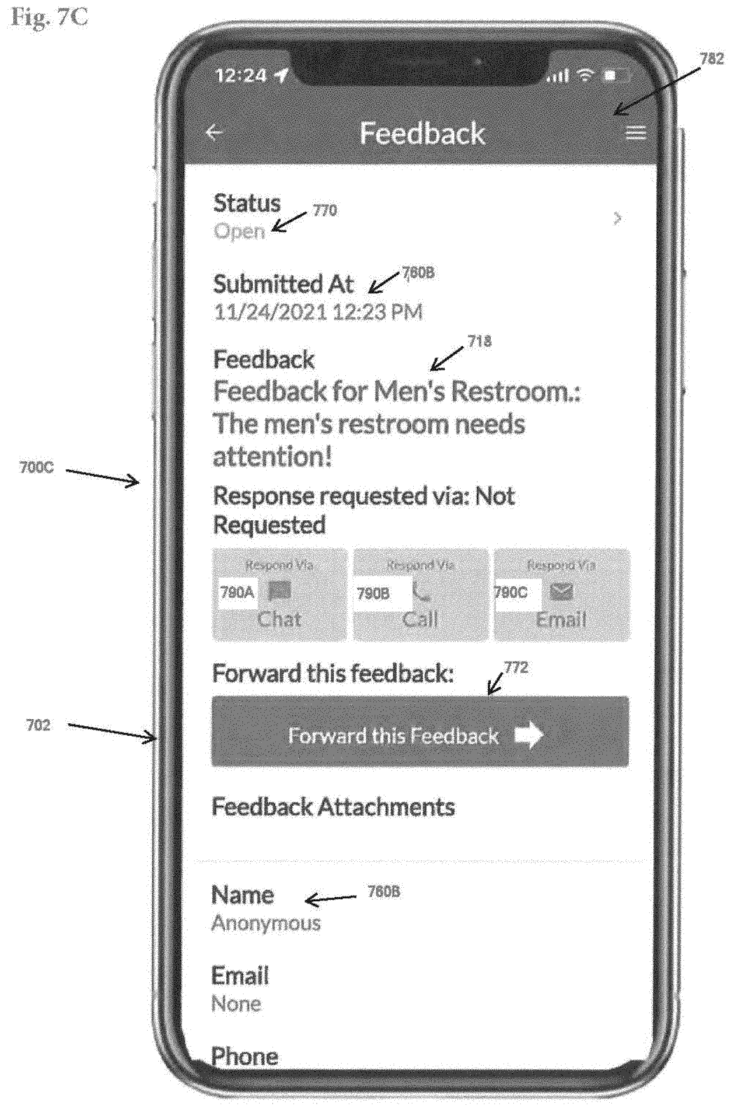

FIG. 7A is an illustration of a feedback system notification 700A. A feedback system user may utilize a computing or mobile computing device 702 to access a feedback response system and/or application 782. The notification 700A may allow for a brief message or informational illustration 784 to be provided.

FIG. 7B is an illustration of a feedback response system and/or application 782 operated on a computing or mobile computing device 702 in a quick view mode 700B. The feedback response system and/or application 782 may allow for information regarding one or more feedback responses 786 to be provided to a user. For example, a user may select to view all feedback responses 788A, open responses 788B, pending responses 788C, and/or resolved responses 788D. In at least one example, the feedback responses 786 may include additional information such as, but not limited to who provided the response 760A, the date 760B the response was provided, the location 768 of the trigger code, and/or the brief message or graphic 718.

FIG. 7C is an illustration of feedback response system and/or application 782 operated on a computing or mobile computing device 702 in a feedback detail mode 700C. A pre-defined message 718 may be provided when the trigger code is activated by a user scanning or capturing the trigger code at a specific location. In at least one example, a pre-defined message 718 can be created that allows for communication of information in a non-intrusive manner for users. A user can scan or capture the code and have the message sent without any additional interactions. These additional interactions may include a user entering information, and/or providing additional engagement beyond a single click if needed.

When the feedback detail mode 700C is utilized a system user can see the response and take additional action on it. In this example, the party 760B providing the feedback response and the date 760B of the feedback response can be provided along with the message 718. The ability to respond to the feedback response 718 can also be provided through a chat button 790A, a call button 790B, and/or an email button 790C. The feedback response 718 may also be forwarded to other individuals or users through a forward message button 772. The status 770 of the feedback response can allow a feedback system user to know if the feedback has already been responded to or is something that may still need to be taken care of.

As stated above, there has been a significant increase in the number of online review sites that allow customers who had bad experiences with a business to leave devastating reviews that can cripple a business. Typically, the business learns about the issue when they see the negative online post or receive a negative message. Customers are less likely to write a detailed message via text message, online submission, survey, or paper comment card, where they know their contact information is being captured and included with the message. Due to social anxiety and fear of making a scene, people are also less likely to let a business' manager know their true experience in a face-to-face conversation. Furthermore, short codes with key words are confusing for average consumers. Many platforms do not allow for the attachment of images or videos and customers do not have an easy way to designate their response method. Lastly, customers cannot leave anonymous feedback using current platforms since it comes from their cell phone.

Oftentimes, anonymous feedback is the most truthful feedback a business can receive. Being that most customers are nervous about a face-to-face confrontation to discuss their issue with management, there needs to be a real-time, simple, electronic method for customers to voice their concerns directly management while still at the business so that management can address the issue and enhance the customer's experience before the customer leaves the business and possibly write a negative online review or tells others about the negative experience. Other current programs use text messaging, emails, surveys, and physical (paper) comment cards to enable customers to communicate with management. However, customers are less likely to use a text platform since short code text platforms and keywords are confusing to customers. Texting a regular phone number gives the impression that you are directly texting the manager which is also perceived as intrusive. Filling out surveys takes too long and rarely addresses the customers' specific issues, face-to-face conversations are intimidating and very few people will write out a physical comment card. Embodiments of the private digital communication system that allows customers to interact with a business in real-time via mobile app or website interaction described in this specification solve such problems by providing a way for businesses and their customers to have a two-way real time electronic conversation while the customer is at the business, or by other means when the customer is not at the location of the business. When a customer uses the mobile app or the website to submit information about an issue, designated staff will receive an immediate notification. Staff can now converse with that customer either by using the app or by using the online tools of the web portal to address the customer's concern. Furthermore, the system has a layer of Artificial Intelligence (AI) which will alert staff as to the nature of the issue and what areas of concern that the customer feedback is about.

The private digital communication system that allows customers to interact with a business in real-time via mobile app or website interaction of the present disclosure may be comprised of the following elements. This list of possible constituent elements is intended to be exemplary only and it is not intended that this list be used to limit the private digital communication system that allows customers to interact with a business in real-time via mobile app or website interaction of the present application to just these elements. Persons having ordinary skill in the art relevant to the present disclosure may understand there to be equivalent elements that may be substituted within the present disclosure without changing the essential function or operation of the private digital communication system that allows customers to interact with a business in real-time via mobile app or website interaction.

1. Any electronic device with internet access (e.g., laptop, tablet computing device, desktop computer, mobile computing device, etc.)

2. Any electronic device that can download an app from either the Google or Apple App stores (in the present disclosure, the app is also referred to as “the Feedback app”)

3. Any electronic device that is capable of obtaining a GPS location

4. A computer, electronic or cellular device that has a keyboard and display

5. A computer, electronic or cellular device that has a camera or smart device app that is capable of scanning Quick Response (QR) codes

6. A web-based platform (also “business web portal”, “business portal”, or “web portal”) that is connected to and controlled by customers with the Feedback app on their device (e.g., installed on their smartphone) or by website interaction from another computing device.

When using the Feedback app on a mobile device or the web portal, a GPS location can be determined so that customers who leave real-time feedback when the GPS location is the same location of the business, it is possible to immediately and personally address the customer if the business chooses to do so. The system also includes a management web portal that allows those businesses to quickly respond to issues received from customers or have their agents (employees or managers) respond from within the Feedback app, from the online management portal, phone call, email, etc. In this way, the Feedback app and the web portal allow businesses to manage the customer-submitted issues/problems by addressing those customers in real-time while the customer is on the premises, as well as by additionally putting notes, tagging issues, closing out issues, forwarding issues via email or text to third parties and generating reports. Lastly, the Feedback app and the customer-side website interaction includes a rating system for users of the platform to rate their experience privately and publicly which gives business owners an overview of the quality of their customers' experience.

The various elements of the private digital communication system that allows customers to interact with a business in real-time via mobile app or website interaction of the present disclosure may be related in the following exemplary fashion. It is not intended to limit the scope or nature of the relationships between the various elements and the following examples are presented as illustrative examples only. Any combination of Devices #1, #2, #3, #4 or #5 will work in connection with #6. Specifically, the Feedback app makes an automatic connection to the Feedback database of the web portal (#6) when any customer launches the Feedback app. Similarly, when the customer uses a web browser with a URL to the business website, the customer can connect to the web platform. As long as the customer has access to any of the devices where the customer can use the device's camera to scan a QR code or has a web browser to enter or click on a URL, they can get to the web portal. The staff at any business can also access the Feedback app or a website associated with the management web portal to respond to customer issues/problems. The devices that they use can be any combination of device #1, #2, #3, #4 or #5 as long as a device is used that can access the internet (website) or an app downloaded from the Apple or Google app stores.

The components of the private digital communication system that allows customers to interact with a business in real-time via mobile app or website interaction of the present disclosure generally work together to allow users/customers to simply put text, pictures/videos or a selected emoji corresponding to their experience level into a web platform that can be easily delivered to any designated staff members of a business. When a problem/issue is submitted, the staff member or any other designated person can receive real-time messaging that customer feedback was submitted. They can see the customer feedback come through as a text message, smart phone app notification, email or it appears in the Feedback app or on the website via the web portal. The messages can be any combination of these methods. Once the customer feedback is received, the business user can respond to the customer in the method that the customer asked for the issue/problem to be responded to (if any). If email or phone call, the business user would use their regular protocol outside of the Feedback app or management web portal. If the customer requested a chat response, then the business user would either use the Feedback app or the management web portal to respond to the customer who sent in the issue/problem information. Any messages sent through the Feedback app or the management web portal would be sent via text message to the customer from one of a bank of private phone numbers. The business user's cell phone number would never be revealed using the private digital communication system and its messaging and communication platforms or the Feedback app. All communications with the customer would be saved to the specific information record submitted by the customer to report the issue/problem. The business user can use the management web portal to add notes to the issue/problem record, change the status of the issue/problem record from “open” to “pending” or “resolved.” Any customer-submitted problem/issue record can also be forwarded to others via text message or email. The business user has the option of hiding the customer's contact information when forwarding the record. Customers can also be blocked from the system if they are sending inappropriate messages. Administrators of the Feedback app and the web portal can add employees and other personnel. Employees can be designated to only receive notifications about customer issues/problems if they are within a half a mile radius of the business's physical location. That way, designated employees who are not at work need not be notified about new customer issues/problems. When customers who receive text messages from the system respond to a text message, it enters in the response into the management web portal as a response chat.

To use the private digital communication system that allows customers to interact with a business in real-time via mobile app or website interaction of the present disclosure, the user may choose various functions when submitting problem/issue information and various manners of transmission (e.g., through the website, through the Feedback app, etc.). Choices of information to include by the customer are many, such as whether to include a picture or video, whether or not to submit the problem/issue anonymously, and, if not anonymously, what information the customer would like to express. They can include any combination of first name, last name, cell phone number, and/or email. If not anonymous but not asking for a response, only their first name is required. If asking for a text message response, the customer will be asked for only their first name and phone number. If only asking for an email, the page will only require first name and email address. If only asking for a phone call, it will only ask for a first name and phone number. If asking for text and email then it will only as for first name, cell phone number and email. If only asking for text and phone call, it will only ask for first name and cell phone number. If only asking for email and phone call, it will only ask for first name, email address and phone number. If other forms of communication are later introduced, the logic will be modified to include the information from the user that will allow for the business to communicate with the user. On some platforms, the business has the option of including a set of emojis reflecting the customer's experience level, rating, or survey before or after the problem/issue information is submitted. If using the emojis, depending on the type of emoji that is chosen, a certain message is given to them depending on the business and what their preference is. Based on the AI layer of the system, the program will automatically tag certain requests with both problem/issue types and whether the information related to the problem/issue is positive or negative. Those also set in motion other gates and triggers based on behavioral rules set by the business.

To make the private digital communication system that allows customers to interact with a business in real-time of the present disclosure, one would design and develop software to run as an app on mobile devices and would code in various methods depending on the operating system of the device or would develop and deploy a website for each business with a management web portal for the business. For the Feedback app, the iOS code is written in Swift and Objective C while the Android version is written in Java. For the website, the management web portal or online web portal version, the code is written in PHP and JavaScript. SQL is also used for database interactions. In order to duplicate the system of the present disclosure, someone would either need to know the code or would need recreate the code by backward engineering the processes that have been created.

The website and the Feedback app use the customer facing web portals or Feedback app functionality that allow customers to leave their feedback as well as all the methods that employees of the business would receive the notification of the issue/problem feedback. Those notifications include website or app push notifications, text message notifications, emails, and web portal notifications. The notifications to employees get triggered when problem/issue feedback is submitted by a customer, or an employee or a customer has sent a chat on the chat platform through the Feedback app, website, or web portal. Furthermore, the private chat message that is received as a text message by the customer and the text message response by the customer that is transformed into an in-application, in website, or in program chat notification to the employee is also foundational in the way the program works. Furthermore, the Artificial Intelligence (AI) layer of the program lets businesses know what categories of issues their customers are submitting problems/issues for and the severity of the positive or negative experience the customer is having with the company when submitting the problem/issue information.

The method in which a business user chooses to receive the notification of the customer feedback can be customized by each individual user however, as long as one of those methods is selected and the user is notified about the customer feedback is all that matters. The ways that someone can be notified about the feedback submitted by a customer are in-app push notification, website or web portal notification, text message, and/or email. Any of these combinations can be chosen. Someone can choose just to have one of the methods chosen such as app push notification, website or web portal notification, text message or email. Someone can choose to have two of the methods chosen such as app push notification and website/web portal notification, app push notification and text message, app push notification and email, website/web portal notification and text message, website/web portal notification and email or text message and email. If someone wanted three of the types of notifications, they may choose any combination in any order, or the user can choose to receive all methods of notification every time a customer issue/problem is submitted.

The present disclosure may include a computing device that can include any of an application specific integrated circuit (ASIC), a microprocessor, a microcontroller, a digital signal processor (DSP), a field-programmable gate array (FPGA), or equivalent discrete or integrated logic circuitry. In some examples, the system may include multiple components, such as any combination of one or more microprocessors, one or more microcontrollers, one or more DSPs, one or more ASICs, or one or more FPGAs. It would also be understood that multiples of the circuits, processors, or controllers could be used in combination or in tandem, or multithreading. Additionally, it would be understood that a browser or program could be implemented on a mobile device or mobile computing device, such as, a phone, a mobile phone, a cell phone, a tablet, a laptop, a mobile computer, a personal digital assistant (“PDA”), a processor, a microprocessor, a micro controller, or other devices or electronic systems capable of connecting to a user interface and/or display system. A mobile computing device or mobile device may also operate on or in the same manner as the computing device disclosed herein or be based on improvements thereof.

The components of the present disclosure may include any discrete and/or integrated electronic circuit components that implement analog and/or digital circuits capable of producing the functions attributed to the modules herein. For example, the components may include analog circuits, e.g., amplification circuits, filtering circuits, and/or other signal conditioning circuits. The components may also include digital circuits, e.g., combinational or sequential logic circuits, memory devices, etc. Furthermore, the modules may comprise memory that may include computer-readable instructions that, when executed cause the modules to perform various functions attributed to the modules herein.

Memory may include any volatile, non-volatile, magnetic, or electrical media, such as a random-access memory (RAM), dynamic random-access memory (DRAM), static random-access memory (SRAM), read-only memory (ROM), non-volatile RAM (NVRAM), electrically-erasable programmable ROM (EEPROM), flash memory, hard disks, or any other digital media. Additionally, there may also be a tangible non-transitory computer readable medium that contains machine instructions, such as, a (portable or internally installed) hard drive disc, a flash drive, a compact disc, a DVD, a zip drive, a floppy disc, optical medium, magnetic medium, or any other number of possible drives or discs, that are executed by the internal logic of a computing device. It would be understood that the tangible non-transitory computer readable medium could also be considered a form of memory or storage media.

It should be noted that the term button has been utilized in an inclusive manner and may also be utilized to indicate an area that allows a user to engage or link to additional data, information, webpages, operations, actions, or otherwise engage with a computing or mobile computing device.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

We claim:

1. A method for private digital communication between customers and businesses comprising:
providing a visual display to a user containing a trigger code;
allowing a user to scan or capture the trigger code with a first computing device;
receiving a pre-defined message from the first computing device upon the scanning or capturing of the trigger code via at least one communication network with a second computing device;
processing the pre-defined message with the second computing device utilizing a set of rules; and
forwarding at least a portion of the pre-defined message according to the set of rules.

2. The method of claim 1, wherein the trigger code is a QR code.

3. The method of claim 1, wherein the trigger code is a bar code.

4. The method of claim 1, wherein the first computing device utilizes a camera to scan or capture the trigger code.

5. The method of claim 1, wherein the pre-defined message includes a sending location.

6. The method of claim 1, wherein the set of rules includes a window range for employee's to receive the portion of the pre-defined message.

7. A private digital communication system that allows customers to interact with a business in real-time via mobile app or website interaction comprising:
a computing device of a customer to communicate an issue to a business at which the customer is located;
a customer trigger for submitting the issue to the business, wherein the customer trigger allows the customer to communicate the issue to the business by way of a pre-defined message submission;
a unique business redirection encoding that is placed at the business location and which can be scanned the computing device of the customer, wherein the unique business redirection encoding loads the customer trigger for the business on the computing device of the customer and sends the pre-defined message; and
wherein a message sent confirmation notification is provided to the customer via the computing device.

8. The system of claim 8, wherein the issue is location specific within the business.

9. The system of claim 8, wherein the customer trigger is a QR code.

10. The system of claim 8, wherein the customer trigger is a barcode.

11. The system of claim 8, wherein the unique business redirection encoding allows for a URL to be loaded and the pre-defined message is created.

12. The system of claim 8, wherein the message sent confirmation notification is a SMS message.

13. The system of claim 8, wherein the message sent confirmation notification is a push notification.

14. The system of claim 8, where in the message sent confirmation notification is a URL or browser based message.

15. A private digital communication system that allows customers to interact with a business in real-time comprising:
at least one computing device coupled to at least one communication network capable of receiving and transmitting at least one set of data with a customer computing device and a business computing device;
wherein the at least one computing device processes the at least one set of data to determine the emotional level of a customer or an agent of the business;
wherein the business computing device is capable of transmitting or receiving a plurality of notifications types, and the at least one computing device is configured to prepare a first notification based on a predefined set of rules for the business computing device, and transmit the first notification based on the processed at least one set of data to allow the agent of the business to respond to a customer.

16. The system of claim 15, wherein customer computing device is a smart phone.

17. The system of claim 15, wherein business computing device is a mobile computing device.

18. The system of claim 15, wherein the emotional level is scored in relation to other message context such as the at least one set of data, which includes a location identifier.

19. The system of claim 15, wherein the first notification is forwarded to a second agent of the business if the agent does not respond in a defined period of time.

20. The system of claim 15, wherein the at least one set of data includes at least one location identifier.
